(19) United States
(12) Patent Application Publication
(10) Pub. No.: US 2022/0327518 A1
(43) Pub. Date: Oct. 13, 2022

(54) Multi-Purpose Physical Smartcard

(71) Applicant: Google LLC, Mountain View, CA (US)

(72) Inventors: Alberto Martin Perez, Los Altos, CA (US); William Alexander Drewry, Nashville, TN (US)

(21) Appl. No.: 17/227,894

(22) Filed: Apr. 12, 2021

(51) Int. Cl. G06Q 20/34; G06Q 20/32; G06Q 20/40; G06Q 20/02; G06Q 20/38

(52) U.S. Cl. CPC G06Q 20/352; G06Q 20/3278; G06Q 20/4014; G06Q 20/02; G06Q 20/382; G06Q 2220/00

(57) ABSTRACT

A multi-purpose smartcard is disclosed. a computer-implemented method of controlling a smartcard. The smartcard can include a near-field communication (NFC) system. The NFC system can be configured to communicate with remote computing systems. The smartcard can include one or more computing chips embedded in the smartcard. The smartcard receives, from a provisioning computing system accessible to a user, a transaction type indicator and transaction data, the transaction type indicator indicating a particular transaction type from a plurality of potential transaction types. The smartcard stores, in the one or more computer-readable media of the one or more computing chips, the transaction data. The smartcard communicates, using the NFC communication system and in accordance with the transaction type, the transaction data to an authentication computing system.

### FIELD

The present disclosure relates generally to smartcards that include a processor and memory.

### BACKGROUND

As computer technology has improved, there has been a corresponding increase in the number of transactions that computing devices can perform. Unfortunately, to be able to perform each transaction, users need to have a computing device capable of performing each transaction. Even a smartphone, which typically is available in relatively small form factors, can, in some situations, be undesirable. In addition, if the computing device is lost or broken, a user can be unable to perform one or more transactions associated with the computing device. As such, a flexible device capable of performing a variety of transaction types in a small form factor is desirable.

### SUMMARY

Aspects and advantages of embodiments of the present disclosure will be set forth in part in the following description, or may be learned from the description, or may be learned through practice of the embodiments.

One example aspect of the present disclosure is directed to smartcard. The smartcard can include a near-field communication (NFC) system. The NFC system can be configured to communicate with remote computing systems. The smartcard can include one or more computing chips embedded in the smartcard, the one or more embedded computing chips comprising one or more processors and one or more computer-readable media, the one or more computer-readable media including executable instructions that, when executed by the one or more processors, cause the smartcard to receive, from a provisioning computing system accessible to a user, a transaction type indicator and transaction data, the transaction type indicator indicating a particular transaction type from a plurality of potential transaction types. The executable instructions can be executed to cause the smartcard to store, in the one or more computer-readable media of the one or more computing chips, the transaction data. The executable instructions can be executed to cause the smartcard to communicate, using the NFC communication system and in accordance with the transaction type, the transaction data to an authentication computing system.

Yet another example aspect of the present disclosure is directed to a computer-implemented method of controlling a smartcard. The method includes receiving, by a smartcard, a registration request from a user computing system, the smartcard having one or more embedded computing chips including a processor and one or more computer-readable media. The method includes transmitting, by the smartcard to the user computing system, a unique smartcard identifier stored in the one or more computer-readable media of the smartcard so that the unique smartcard identifier can be associated with a particular user account at a registration server. The method includes receiving, by the smartcard from the user computing system, a user credential code for authenticating an identity of a user as part of a transaction with a computing system. The method includes storing the user credential code in the one or more computer-readable media of the one or more computing chips. The method includes communicating, by the smartcard, the user credential code to an authentication computing system via a smart reader.

One example aspect of the present disclosure is directed to computing system for registering a smartcard. The computing system comprises one or more processors. The computing system comprises one or more non-transitory, computer-readable media that store instructions that when executed by the one or more processors cause the computing system to perform operations. The one or more operations can comprise transmitting a registration request to a smartcard, the smartcard including processing circuitry and memory. The one or more operations can comprise receiving, from the smartcard, a unique smartcard identifier. The one or more operations can comprise transmitting the unique smartcard identifier to a remote registration system to be stored in associated with a user account of a user. The one or more operations can comprise determining, based on user input from the user, a requested transaction type and transaction data associated with the requested transaction type. The one or more operations can comprise transmitting, to the smartcard, a transaction type indicator and the transaction data, the transaction type indicator indicating a particular transaction type from a plurality of potential transaction types.

Other example aspects of the present disclosure are directed to systems, apparatus, computer program products (such as tangible, non-transitory computer-readable media but also such as software which is downloadable over a communications network without necessarily being stored in non-transitory form), user interfaces, memory devices, and electronic devices for implementing and utilizing touch sensors such as capacitive touch sensors.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which refers to the appended figures, in which:

FIG. 1 illustrates an example computing environment including a smartcard in accordance with example embodiments of the present disclosure;

FIG. 2 is an example computing environment that includes a smartcard, a user computing system, and a third-party computing system in accordance with example embodiments of the present disclosure;

FIG. 3 is an example computing environment that includes a smartcard, a user computing system, and a server computing system in accordance with example embodiments of the present disclosure;

FIG. 4 is a flow chart representing interactions between a smartcard, a user computing system, and a third-party computing system in accordance with example embodiments of the present disclosure;

FIG. 5 is a flow chart representing interactions between a smartcard, a user computing system, and a user computing system in accordance with example embodiments of the present disclosure;

FIG. 6 is a flowchart depicting an example process of provisioning a smartcard to perform a particular function in accordance with example embodiments of the present disclosure.

FIG. 7 is a flowchart depicting an example process of registering a smartcard with a registration server in accordance with example embodiments of the present disclosure; and

FIG. 8A is a diagram displaying an example interface for registering a smartcard with a user account in accordance with example embodiments of the present disclosure.

FIG. 8B is a diagram displaying an example interface for enabling a smartcard to perform a second factor authentication transaction in accordance with example embodiments of the present disclosure.

FIG. 8C is a diagram displaying an example interface for enabling a smartcard to perform a second factor authentication transaction in accordance with example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed to a multi-function smartcard (e.g., a plastic credit card) with an embedded computer chip that enables the smartcard to perform a variety of functions. The embedded computer chip can include one or more processors and memory such as one or more computer-readable media. The one or more processors and the memory can implement a secure element (e.g., a dedicated portion of the computing chip that stores sensitive data securely). The embedded computing chip can implement a set of executable instructions such as a computer application (e.g., a Java Applet) by storing the relevant data in the memory and using the processor to execute the application as needed. The computer application can enable the smartcard to be customized to perform a variety of different functions (e.g., a plurality of different transaction types). To do so, a smartcard can be associated or paired with a user computing device (e.g., a smartphone or personal computing system) or a user account. Using a built-in NFC communication system or other communication systems, the smartcard can communicate with the user computing system (or any computing system designated by the associated user) to receive instructions as to which function is needed and any data needed to perform the functionality.

The user computing system can transmit instructions to the smartcard to perform a particular functionality (or transaction type). The instructions can include a transaction type indicator and one or more security codes or identifiers associated with the designated transaction type. For example, the smartcard can be used to implement a method for performing second factor authentication during a transaction with a computing system (e.g., logging into an account or performing a purchase transaction). To do so, a user can communicate, via an NFC communication system, instructions designating the desired transaction type as second factor authentication. The user can also transmit data required to perform the designated transaction type (e.g., an identity verification code) to the smartcard. A user can then bring the smartcard with them (e.g., when a smartphone is lost or carrying it would be inconvenient) and place the card within the communication range of an NFC communication system associated with a particular transaction. When placed within communication range (e.g., typically less than ten centimeters for an NFC system) the smartcard can transmit the identity verification code to authenticate the user's identity when requested.

To ensure security, the computing chip can be created with a unique card identifier associated with the card at the time of fabrication. When a user purchases the smartcard, the unique card identifier that is permanently stored in the chip can be associated with the user (e.g., stored in the user account). For example, as part of the registration process, the unique card identifier associated with the smartcard can be received from the card by a user computing system via an NFC communication system. The user computing system can transmit the unique card identifier, along with the account identifier of the user, to a remote registration server so that the card is associated with the user account.

By way of example, the smartcard can be used to perform second factor authentication for transactions that the user is performing. For example, a user can, through the NFC communication system of the user computing device, transfer one or more user authentication codes to the smartcard. The user can then, when second factor authentication is needed, place the smartcard near an appropriate NFC communication system, such that the smartcard can, using its NFC communication system and appropriate communication protocols enabled by executable instructions installed on the embedded computing chip, provide the authentication codes to a third-party system as a second factor to authenticate the user.

More particularly, an example of a smartcard is a credit card with an embedded computing chip. The credit card can be a small thin rectangular card made of a variety of materials, including, but not limited to plastic resins and/or a variety of metal alloys. The smartcard can also include an embedded computing chip. The embedded computing chip can include an NFC communication system. For example, the NFC communication system can be a passive device that is enabled by the field provided by a transponder outside of the smartcard.

The embedded computing chip can include one or more processors and memory. The memory can store instructions associated with a computer application which the processor(s) can execute. The computing application (e.g., a Java applet) can enable the smartcard to provide customizable functionality to a user. To provide customizable functionality, the memory can be configured to store data associated with one or more functions, including instructions as to how to perform the functions and any data needed to perform the function. The memory can include a section (e.g., part of the computing chip or a distinct second computing chip communicatively coupled to the first computing chip) that is cryptographically secure in order to implement a secure element.

The secure section of the computing chip can, using the computer application, encrypt stored data to ensure that stored data is only accessible for the functions for which it has been designated. The computing application can use a plurality of cryptographic algorithms to encrypt and decrypt communications with third-party systems. In some examples, each function and each particular third-party system can use a different communication protocol to effectively send and receive information. As such, the user can, when selecting which function the smartcard is to perform, provide instructions for the communication protocol with the associated computing systems, including which encryption algorithms will be used. Examples of possible functions can include second factor authentication, virtual keys, loyalty information, payment transactions, transit ticketing, user identification (e.g., employee identification), and so on.

In some examples, the NFC communication system can be included in the embedded computing system. In this example, the application can be installed in the memory of the NFC communication system. In some examples, the application can include executable instructions. The application can, when executed by one or more processors associated with the embedded computing chip, perform a variety of different functions including, executing communication protocols to communicate with one or more third-party computing systems using one or more cryptographic algorithms as part of a communication protocol and receive instructions associated with particular functionality types from the user.

When the smartcard is manufactured, a unique smartcard identifier can be generated and stored in the memory of the embedded computing chip. In some examples, the unique card identifier can be permanently written into the computer chip memory such that it cannot be changed and will always be associated with and identify a particular smartcard. In some examples, the unique smartcard identifier for the smartcard can be stored in a database associated with the manufacturer of the smartcard. In other examples, the unique smartcard identifier can be stored in a database associated with a service provider that provides the smartcard to a user (e.g., a financial institution, an online service provider, or other organization). In this way, when the smartcard is used, the unique smartcard identifier can be identified from the database to determine which specific smartcard has been used and determine any associated information.

In some examples, the unique card identifier can be used to associate the smartcard with a particular user account. To do so, when a user purchases or otherwise obtains a smartcard, the user can perform a registration process with the smartcard to associate it with a particular user. In some examples, a registration application can be made available by the organization associated with the smartcard to register the card. The user can place the smartcard within communication range (e.g., NFC communication range) of a user computing system that is running a registration application. Examples of user computing devices include personal computers, laptops, smartphones, wearable computing devices, tablet computing devices, or any other computer device capable of communicating with the smartcard and executing a registration application.

In some examples, the registration can be performed via an internet browser or other application that connects to a remote registration service (e.g., provided by the service associated with the user account in which the smartcard is to be registered). The user can log into (or otherwise indicate) their associated user account such as an email account, a payment account, or any other type of user account. Once the user has logged into their user account (e.g., by providing user verification details), the user computing system can connect to the smartcard and request the unique smartcard identifier stored on the smartcard via an NFC communication system.

The smartcard can, via an NFC communication system, transfer the stored unique smartcard identifier to the user computing system. The user computing system can provide the unique smartcard identifier to a remote registration server. The remote registration server can store the unique smartcard identifier such that it is associated with the user account. In this way, in the future, when the unique smartcard identifier is detected, the associated user account can be determined from the registration server.

Once the smartcard has been registered with the specific user account, the user can use it to provide a plurality of potential transaction types. For example, the smartcard can be used to perform second factor authentication, payment transactions, password provision, to act as a virtual key, to pay fares or tolls for public transportation, act as an employee ID badge, and so on.

To enable the smartcard to provide functionality for a plurality of different transaction types, the smartcard can communicate via an NFC communication system to transfer and receive information from a user computing device. When a particular transaction type is required, the user can control the user computing device to provide the smartcard with a transaction type indicator identifying the desired transaction type and deliver any required data to make such a transaction possible. Using a smartcard interaction application, the user can select a specific transaction type and transmit the transaction type indicator to the smartcard. In some examples, a transaction type can describe the general type of transaction and may include a plurality of transactions with different specific institutions or organizations. For example, the smartcard may act as a virtual key (as the transaction type) but the specific codes and/or communication process can be different for each lock type (e.g., different vehicle brands, different lock types, different garage door openers, and so on). In some examples, a specific institution can issue or be associated with the smartcard (e.g., a particular bank) but the smartcard can allow transactions associated with other institutions. For example, a specific credit card company can issue the smartcard but the smartcard can enable the user to use credit cards associated with other credit card companies.

The user computing system can transfer transaction data to the smartcard to enable it to accomplish the transaction type selected by the user (e.g., through the smartcard control application). For example, a particular transaction type may have associated codes, passwords, or other identifying information required to complete the transaction. This transaction data can be transmitted to the smartcard at the same time as the transaction type indicator.

The smartcard can receive the transaction type indicator and any associated transaction data from the user computing system and store it in memory associated with the embedded computing chip. In some examples, the memory is able to store an identifier type and transaction data for a plurality of different transaction types. In other examples, the memory is limited such that transaction data for only one or a predetermined number of transaction types can be stored on the smartcard at any given time. As noted above, in some examples, the transaction data can be stored in a cryptographically secure chip or portion of memory (e.g., a secure element within the card.)

Once the transaction type indicator and any associated transaction data is stored, the user can remove the smartcard from the communication range of the user computing system and travel to a location in which the smartcard is to be used. Because the smartcard is able to independently perform the transaction, the user does not need to bring the user computing device or any other device or equipment to perform the selected transaction.

The user can place the smartcard within communication range with a third-party communication system when needed. For example, NFC communications can be enabled within a range of a few centimeters (e.g., generally less than 5 centimeters). In some examples, the third-party communication system can generate an electromagnetic field that can enable the embedded computing chip to provide information to the third-party computing system.

In some examples, the specific information provided by the embedded computing chip is determined based on information provided to the smartcard by the user computing system. In this way, each transaction and/or transaction type can have an associated communication process detailing what information is exchanged and the order in which it is exchanged. The smartcard can use this information to ensure that its communication with a third-party computer system follows established procedure and communication processes to achieve the desired result. In addition, this can prevent the smartcard from communicating with other third-party computer systems when unintentionally placed in the communication range of a third-party computing system.

A specific use case is to provide second factor authentication for transactions. For example, when a transaction takes place online, including but not limited to payment transactions, identity verification, logging into an account online, and so on, a remote computing system may use two different verification methods (or factors) to verify the user's identity. A common example can include using a password or pin number to initially log a user into a service or initiated transaction and then using a different verification method to verify that the initial verification. The second factor can include sending a text or code to an email address or phone number that the user has previously registered as belonging to them. In some cases, however, the user may not have a second factor authentication device (such as a smartphone) with them at all times and is thus unable to take full advantage of this extra security that second factor authentication provides.

In some examples, the second factor authentication can be performed in accordance with a two-factor authentication standard, such as the universal 2^{nd} factor standard established by the FIDO alliance. To do so, the smartcard and another computing system can establish communication and then exercise a challenge-response authentication protocol using public-key cryptography methods and a unique device key associated with the smartcard.

In accordance with example embodiment of the present disclosure, a smartcard can be used to provide a relatively lightweight and easy method for providing second factor authentication. To enable the smartcard to provide second factor authentication functionality, the user can, through the user computing system, transmit a transaction type indicator that represents second factor authentication. The user can also transmit transaction data to the smartcard. The transaction data can include data indicating the specific communication process used to provide second factor authentication in this case and a user identity confirmation code that can be used to provide second factor authentication. In some examples, the user identification confirmation code is previously registered with a particular merchant and/or service provider such that it can reliably be used to provide confirmation of the user's identity.

Once the transaction indicator type and transaction data have been stored at the smartcard (e.g., in a secure element of the embedded computing chip), the user can proceed to initiate the transaction for which second factor authentication is needed. The user can, when second factor authentication is requested, place the smartcard within the communication range of an appropriate NFC communication system (e.g., the user computing system or a third-party system associated with the second factor authentication).

Another transaction type that can be implemented by the smartcard is a payment transaction. To enable payment transactions with the smartcard, the user can transmit a transaction type indicator to the smartcard that indicates that a payment transaction is requested. In addition, the user can transmit transaction data to the smartcard that can include payment information that can be used to provide payment in a commercial transaction. The payment data can be one of bank account data, credit card data, spending account data, and any other payment account. The payment data can be stored by the smartcard (e.g., in the memory associated with the embedded computing chip or in a secure element included in the smartcard).

The user can take the smartcard with them to a merchant location without requirement of any other cards, devices, or other object capable of enabling a payment transaction. When the payment transaction occurs (e.g., when the user purchases an item or a service from a merchant), the user can, as part of the payment transaction, place the smartcard within communication range and the smartcard can, using stored transaction data information about how the payment transaction is to be performed (e.g., as may be received from the user computing system), provide the transaction data to a third-party computing system to enable the transaction to occur.

Another transaction type can include providing a password or identity code to enable access to a location or a system (e.g., similar to an employee badge). Similar to other transaction types, the user can provide the transaction type identifier and any associated transaction data such as a password or a pin to be stored within the smartcard. The user can carry the smartcard on their person without requirement of another device (e.g., such an employee ID card), and in response to being notified that the password or identity code is required, place the smartcard within communication range of a third-party NFC communication system or computing device. The smartcard can then provide the associated transaction data in accordance with the predetermined communication process.

In another example, the smartcard can serve as a virtual key to enable a user to open a lock for a house, vehicle, or other locked location. The user can provide a transaction type indicator that indicates that the card is to be used as a virtual key to access a vehicle or locked location. The user can provide transaction data such as a specific code that grants access to the vehicle or locked location. This information can be stored by the smartcard. Thus, the user only needs to have their smartcard to open or access a vehicle or a locked location. In addition, the smartcard can allow the user to operate a vehicle based on communicating stored transaction data to the vehicle via an NFC communication system.

Another functionality type can include providing payment information for a transit system. For example, many transit systems (e.g., bus systems, subway systems, train systems, above ground transit systems, and so on) require fares or proof of identification for user access. Smartcards can be used to provide information about payment accounts and or existing user identification information that will enable the user to access the transit system. To use the smartcard this way, the user can provide instructions associated with accessing a particular transit system. The instructions can include the transaction data needed to access the transit system and the specific communication protocol used by the transit system. The user can then take the smartcard with them to the transit system and place it within the communication range of a third-party system to access the transit system. The smartcard can use the predetermined communication protocol to provide the needed information to the smartcard to the transit system and grant the user access in the transit system.

The following provides an end-to-end example of the technology described herein. A smartcard can include an NFC communication system configured to communicate with remote computing systems. The smartcard can further include a computing chip embedded in the smartcard, the embedded computing chip comprising one or more processors and one or more computer-readable media. In some examples, the smartcard stores a unique card identifier in one or more computer-readable media. The one or more computer-readable media can include executable instructions that, when executed by the one or more processors, cause the smartcard to perform one of a plurality of potential functionalities.

In some examples, the smartcard can receive, from the user computing system, a registration request. The smartcard can transmit, to the user computing system, the unique card identifier to the user computing system for storage at a remote server computing system. The smartcard can receive, from a user computing system, a transaction type indicator and transaction data, the transaction type indicator indicating a particular transaction type from a plurality of potential transaction types. In some examples, the transaction data includes information describing a communication process associated with the received transaction type.

The smartcard can store, in the computer-readable media of the computing chip, the transaction data. In some examples, the computing chip computer-readable media stores transaction data for a plurality of transaction types simultaneously. In other examples, the smartcard can have limited storage space for transaction data (e.g., limited to space for a single transaction or for a small number of transactions). In this example storing the transaction data in the computer-readable media of the computing chip further comprises removing, from the computer-readable media of the computing chip, previous transaction data associated with a previous transaction type and replacing it with the transaction data for the indicated transaction type.

The smartcard can communicate, using the NFC communication system and in accordance with the transaction type, the transaction data to a third-party computing system. The communication to the third-party computing system is initiated when the smartcard can be placed within NFC communication range of the third-party computing system by a user. The communication to the third-party computing system can be organized based on the communication process described in the transaction data.

In some examples, the indicated transaction type can be second factor authentication. In this case, the smartcard can receive, from the user computing system, a user credential code. The user credential code can be previously determined by a remote server system for which the second factor authentication is required. The smartcard can transmit, using the NFC communication system, the user credential code to a third-party computing system in response to the user placing the smartcard within communication distance of the third-party computing system.

In some examples, the indicated transaction type is accessing a vehicle. The smartcard can receive, from the user computing system, vehicle access data. The smartcard can transmit, using the NFC communication system, the vehicle access data to a vehicle in response to the user placing the smartcard within communication distance of the vehicle. The vehicle can then provide access to the user of the smartcard.

In some examples, the transaction type can be a transportation payment associated with a particular transit system. The smartcard can receive, from the user computing system, transmit account data, wherein the transmit account data is associated with accessing a transit system. The smartcard can transmit, using the NFC communication system, the transit account data to a third-party computing system associated with the transit system to allow the user to access the transit system. For example, the smartcard can allow a user to access and/or pay fare for a subway system.

In some examples, the indicated transaction type can be a payment transaction. The smartcard can receive, from the user computing system, payment account data, wherein the payment account data is associated with a payment account of the user. The smartcard can transmit, using the NFC communication system, the payment account data to a third-party computing system associated with a merchant to provide payment for a transaction. In some examples, the payment account data can include the payment details for a single payment account (e.g., a single credit card). In other examples, the payment account data can include information for a plurality of payment accounts. In this case, the user can later instruct the smartcard to use a particular payment account in a given situation.

In some examples, the indicated transaction type can be a loyalty data transfer. The smartcard can receive, from the user computing system, loyalty account data, wherein the loyal account data is associated with a loyalty account with a particular merchant. The smartcard can transmit, using the NFC communication system, the loyalty account data to a third-party computing system associated with the particular merchant.

Embodiments of the disclosed technology provide a number of technical effects and benefits, particularly in the areas of multiple purpose communication devices. In particular, embodiments of the disclosed technology provide improved techniques for enabling multiple different use cases in a single smartcard. For example, utilizing embodiments of the disclosed technology, a single smartcard can act as a payment device, a car access mechanism, an identification device for second factor authentication and transit system, and so on. This enables a benefit to users by reducing the cost and increasing the flexibility associated with having all the functionality enabled in a small form factor. As such, the disclosed embodiments enable additional functionality while reducing the total cost.

Additionally, the disclosed technology can provide increased security by adding an additional factor for multi-factor authentication. For example, when the smartcard is used as a second-factor authentication tool, a user can user the smartcard in place of another authentication factor, such as a smartphone or tablet computer. In this way, a given device (such as a smartphone) does not act as the second factor for transactions that begin on the device. This prevents theft or fraud if the phone is lost or stolen.

With reference now to the figures, example aspects of the present disclosure will be discussed in greater detail.

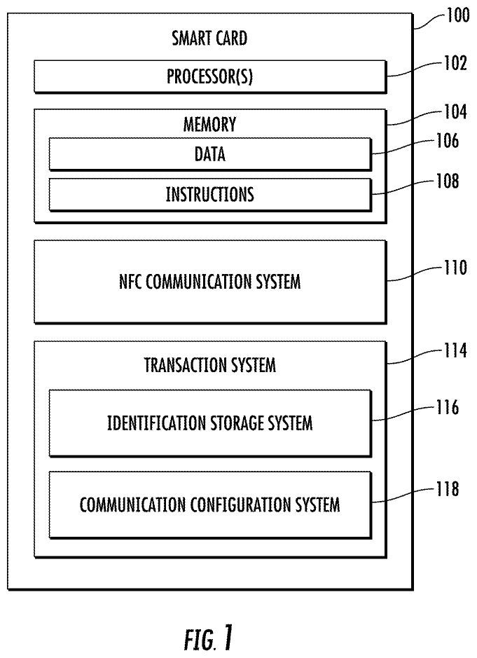

FIG. 1 illustrates an example computing environment including a smartcard in accordance with example embodiments of the present disclosure. In this example, the smartcard 100 can include one or more processors 102, memory 104, an NFC communication system 110, and a transaction system 114.

In more detail, the one or more processors 102 can be any suitable processing device that can be embedded in the form factor of a credit card to create a smartcard. For example, such a processor can include one or more of: one or more processor cores, a microprocessor, an ASIC, a FPGA, a controller, a microcontroller, etc. The one or more processors can be one processor or a plurality of processors that are operatively connected. The memory 104 can include one or more non-transitory computer-readable storage mediums, such as RAM, ROM, EEPROM, EPROM, flash memory devices, etc., and combinations thereof. The memory 104 and at least one processor 102 can be a part of a cryptographically secure portion of a particular smartcard's one or more embedded computing chips, acting as a secure element. The secure element can safely store information received from users and information used by a secure transaction application (e.g., a Java applet).

The memory 104 can store data 106 and instructions 108 which are executed by the processor 102 to cause the smartcard to perform operations. As noted above, the stored data 106 can include transaction data received from a user computing system or other provisioning computing system. In some examples, the transaction data can include identification codes, passwords, predetermined signals or numbers, or any other information that can be used by the smartcard to perform any of the plurality of transaction types enabled by the smartcard. In addition, the transaction data can include information describing specific communication protocols received from the user computing system. The communication protocols can include instructions describing which information is to be exchanged (including any handshake protocols), the order the information is to be exchanged, and any cryptographic algorithms to be used during the communication. In some examples, the instructions 108 can include instructions used to execute a Java applet.

The NFC communication system 110 can implement near field communication (NFC) to allow communication between the embedded computing chips of the smartcard and one or more remote computing systems. In some examples, the near field communication system 110 can communicate over a short distance such as 10 centimeters or less.

Transaction system 114 can include an identification storage system 116 and a communication configuration system 118. The identification storage system 116 can store information received from a user computing device. In some examples, the received data can include a transaction type indicator. In some examples, the transaction type indicator can represent a particular transaction that a user selects for the smartcard 100 to perform. The transaction types can include, but are not limited to, a second-factor authentication, a purchase transaction, a virtual key transaction, and a user identification transaction.

In some examples, the received data can also include transaction data. Transaction data can include information describing specific information needed to perform the selected transaction type. For example, if the selected transaction type is payment, the transaction data can include information describing one or more payment accounts that can be used to perform the payment transaction. In other examples, the transaction type is a virtual key transaction to act as a virtual key to access a car or a building. In this case, the transaction data can include a specific code or sequence of signals that will cause the lock on the vehicle or home to be unlocked.

In some examples, the smartcard receives information that describes not just a general transaction type but the specific transaction to be performed. For example, if the transaction is a payment transaction, the transaction data can include the specific account, from a plurality of possible accounts, that should be used for the payment. Similarly, if the selected transaction type is a virtual key transaction, the user can identify specific credentials for the virtual key and/or identify the particular lock for which the virtual key is needed. For example, the user's vehicle and home may have different codes that grant access and those systems may be run by different companies that use different communication protocols. Thus, the transaction data can enable the smartcard to differentiate between different types of virtual keys for each potential transaction.

In some examples, the transaction data can also include specific information about the form of the transaction to occur including the communication protocol that will be used on the specific transaction. Because the smartcard can be used for a variety of different transaction types, the specific data to be transmitted, and the order in which the data is transmitted may vary from transaction type to transaction type. In some examples, the user can provide information about the specific communication protocol to be used to the smartcard when the transaction type indicator is transmitted from the using computer device. The communication configuration system 118 can use information provided by the user or other source to ensure that the smartcard can communicate with the correct authentication computing system using the correct protocol and provide the correct information.

In this way, the smartcard can receive information from the user computing system at a first time. That information can be stored on the smartcard and the user can take the smartcard with them without a need to also take the accompanying user computing device. When the user needs the functionality provided by the smartcard at a second time, the user can place the smartcard near the NFC communication system of a third-party computing system (e.g., at a merchant shop or near the vehicle that needs to be unlocked). In this way, the user can perform the desired transaction without having to take a bulky or inconvenient computing system with them.

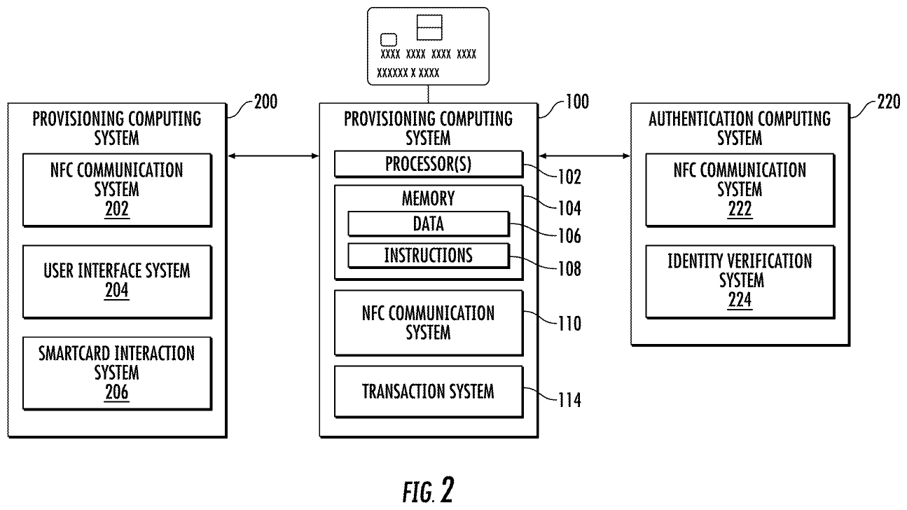

FIG. 2 is an example computing environment that includes a smartcard 100, a provisioning computing system 200, and an authentication computing system 220 in accordance with example embodiments of the present disclosure. As noted above, the smartcard 100 can include one or more processors 102, memory 104, an NFC communication system 110, and a transaction system 114. The one or more processors 102 can be any suitable processing device that can be embedded in the form factor of a credit card and the memory 104 can include one or more non-transitory computer-readable storage media. At least a portion of the one or more processors 102 and memory 104 can implement a secure element that keeps data cryptographically secure.

The NFC communication system 110 can implement a near field communication (NFC) protocol to allow communication between the embedded computing chip(s) of the smartcard and one or more computing systems, including but not limited to a provisioning computing system 200 (e.g., a user computing system) and a third-party computing system 220. In some examples the near field communication system 110 can communicate over a short distance such as 10 centimeters or less.

The transaction system 114 can be used to organize and control transactions with other computing systems (e.g., the provisioning computing system 200 and the authentication computing system 220). To do so, the transaction system can employ the NFC communication system 110 to receive data from another computing system (e.g., the provisioning computing system 200 and the authentication computing system 220) or transmit data to another computing system.

In some examples, the transaction system 114 can transmit a unique card identifier associated with the smartcard 100 to a user computing system as part of the registration process. This unique smartcard identifier can be a unique number that is associated with the smartcard 100 at the time the smartcard 100 is initially created and can be written into the computer-readable media of the smartcard such that it cannot be changed.

In some examples, the smartcard 100 can receive transaction data associated with a particular transaction type from a provisioning computing system 200. In some examples, the transaction data can include data describing a specific communication protocol associated with the selected transaction type. The communication protocol can describe what data is to be transmitted and in what order it should be transmitted, along with other information such as what cryptographic methods are to be used for communication. The transaction system 114 can use this information about the communication protocol such that when the smartcard 100 is brought within communication range of an authentication computing system 220 or a computer system that is in communication with an authentication computing system 200 (e.g., an NFC terminal in a merchant store), the smartcard 100 can transmit the relevant transaction data to the authentication computing system 220 based on the communication protocol received from the provisioning system 200.

In some examples, the smartcard can communicate with a smart reader. A smart reader can be an active component in an NFC transaction that can read data from NFC cards or other devices. In some examples, the smart reader can read relevant data from the smartcard. In this example, the smartcard can make the appropriate data available to the smart reader.

In some examples, the provisioning computing system 200 can include an NFC communication system 202, a user interface system 204, and a smartcard interaction system 206. It should be noted that the provisioning computing system 200 can be a user computing system that enables the smartcard 100 to perform a plurality of functions once the smartcard 100 has been registered (see the registration process described herein) with a specific user. Thus, the smartcard 100 can provisioned to perform each of the possible interaction types as needed by a user from their personal computing device, as opposed to cards that are provisioned only once at the time of manufacture. The provisioning computing system 200 can use these components to interact with the smartcard 100 and cause the smartcard 100 to perform an interaction selected by a user. The NFC communication system 202 can be any communication system capable of performing the NFC communication protocol. In some examples, the NFC communication system 202 can be an active component that provides power to the NFC communication system 110 of the smartcard 100 when it comes within range. The NFC communication system 202 can be controlled by the smartcard interaction system 206 that provides the information the NFC communication system 202 transmits to the smartcard 100. The NFC communication system can also instruct the NFC communication system 202 what information should be expected to be received from the smartcard 100.

The user interface system 204 can enable a user of the provisioning computing system (e.g., a laptop, a smartphone, a personal computer, a tablet computer, a wearable computing device, and so on) to select a particular interaction or interaction type that the smartcard should be provisioned to perform. For example, the smartcard can be provisioned to perform second-factor authentication. To do so, the user can, through the smartcard interaction system 206, select second-factor authentication as the desired transaction type and provide additional details as to what type of second-factor authentication is to be delivered. For example, second-factor authentication can be used for a variety of different systems and service providers and so the user can select a specific type of second-factor authentication that is to be desired and provide any associated authentication codes for transmission to the smartcard 100.

In some examples, the smartcard interaction system 206 can use user input received by the user interface system 206 to generate communications for the smartcard 100. For example, if the user input designates the transaction type as a second-factor authentication, the smartcard interaction system can generate a transaction type indicator that is associated with the second-factor authentication transaction. The smartcard interaction system 206 can, using the NFC communication system 202, transmit the generated transaction type indicator to the smartcard 100.

The smartcard interaction system 206 can also generate transaction data associated with a particular transaction type. Transaction data can include information needed to perform the selected transaction type including but not limited to identification codes, account numbers, authentication codes, passwords, and so on. In some examples, the transaction data can be based on information received from user input from the user interface system 204. In addition, the transaction data can include information describing particular communication protocols needed for a particular interaction.

In some examples, the authentication computing system 220 can be associated with a third-party system. For example, the authentication computing system 220 can be associated with a merchant, a service provider, or a system outside of the control of the user of the smartcard 100. In some examples, the authentication computing system 220 can include an NFC communication terminal (e.g., inside a store) that communicates with a remote authentication server via a network.

The authentication computing system 220 can include an NFC communication system 222 that can receive transaction data from the smartcard 100. The authentication computing system 220 can include an identity verification system 224 that can compare the received transaction data to stored verification data to authenticate a user or a system.

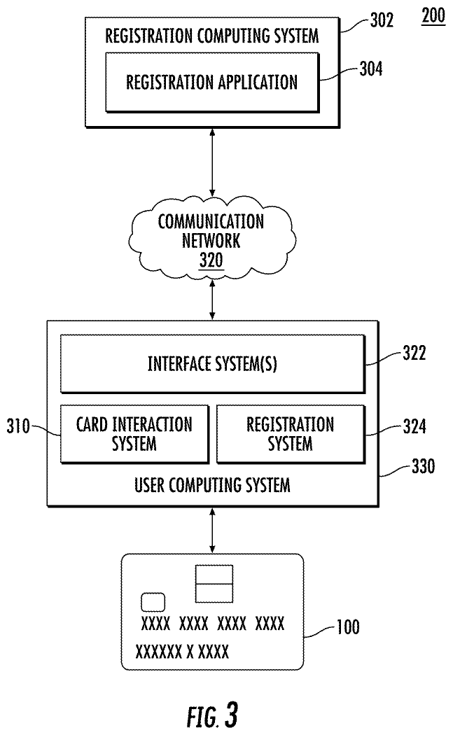

FIG. 3 is an example computing environment that includes a smartcard 100, a user computing system 330, and a server computing system in accordance with example embodiments of the present disclosure. As noted above, the smartcard 100 includes an NFC communication system that allows it to communicate with the user computing system 330. Similarly, the user computing system 330, which one example of a specific implementation of the provisional computing system 200 depicted in FIG. 2, can include an NFC communication system that allows the user computing system 330 to communicate with the smartcard 100 when the smartcard comes within the communication range of the user computing system.

In some examples, the user computing system 330 can include an interface system 322, a card interaction system 310, and a registration system 324. The interface system 322 can include both an NFC communication system for communicating via NFC and an interface system for communicating over a network 320.

To register a smartcard 100, the user computing system 330 can receive input from a user directing the user computing system 330 to begin the registration process. The registration system 324 can, using the card interaction system 310, request a unique card identifier from the smartcard 100. To do so, the smartcard 100 can be brought within communication range from the user computing system (e.g., within a distance in which it is able to communicate via the NFC communication protocol). The card interaction system 310 can generate a request to be transmitted to the smartcard 100 via one or more interface systems 322.

The smartcard 100 can include an embedded processor with one or more computing instructions (e.g., an application such as a Java Applet) that can, in response to receiving a request for the unique smartcard identifier, transmit the unique smartcard identifier to the user computing system 330. A unique smartcard identifier can be stored in computer-readable media on the smartcard 100. The card interaction system 310 can receive the unique smartcard identifier from the smartcard 100 via one or more interface systems 322. The card interaction system 310 can transmit the received unique smartcard identifier to the registration system 324.

The registration system 324 can, after receiving the unique smartcard identifier, determine the user account with which the smartcard is to be registered. In some examples, the user will log in to the user account with which the smartcard will be registered as part of the registration process. Once the registration system determines the user account with which the smartcard is to be registered, the registration system 324 can transmit, via one or more interface systems through communication network 320 a registration request to the server computing system 300. The registration requests can include the user account (or an identifier thereof) and the unique smartcard identifier received from the smartcard 100.

The server computing system 300 can include, among other components, a registration application 304. The registration application 304 can enable users to register smartcards 100 with their specific user accounts. In some examples, registering smartcards 100 with specific user accounts can enable the server computing system to ensure that the card is not used by anyone other than the user with which it is registered.

The registration application 304 can receive, via the communication network 320, a registration request from the user computing system 330. The registration request can include information identifying a user account and a unique card identifier associated with the smartcard 100 to be registered. In response to receiving the registration request, the registration application 304 can store the unique smartcard identifier in association with the identified user account. Once the unique card identifier has been stored in association with user account, the unique smartcard identifier can then be used in the future to determine the specific user account with which it is associated.

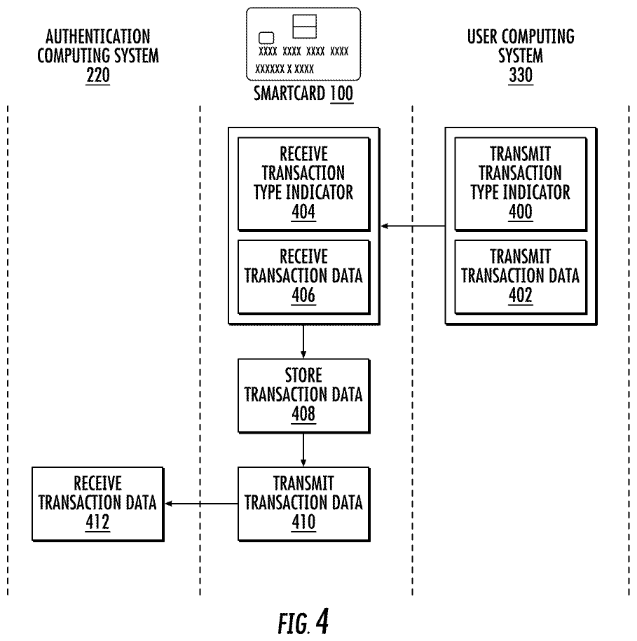

FIG. 4 is a flow chart representing interactions between a smartcard, a user computing system, and a third-party computing system in accordance with example embodiments of the present disclosure.

In some examples, the user computing system 330 can, in response to user input, transmit data to the smartcard 100. Transferring data to the smartcard 100 can include transferring a transaction type indicator 400 to the smartcard 100 and transferring transaction data 402 to the smartcard 100. In some examples, the transaction type indicator and the transaction data are transmitted as a single packet of information. In some examples, the transaction type indicator can represent a particular transaction type that is to be conducted by the smartcard 100. In some examples, the transaction data includes any data necessary to perform the indicated transaction type including, for example, a user identification token, one or more passwords, an access code, an employee ID number, an account number, and so on.

In some examples, the smartcard 100 can receive the transaction type indicator 404 and receive the transaction data 406. The transaction data can be stored 408 in the computer-readable media associated with the smartcard 100. Once the transaction data has been stored in memory associated with the smartcard 100, the smartcard 100 can be taken by the user to a location remote from the user computing system 330.

In some examples, the user can put the smartcard 100 within communication distance of an authentication computing system 220 (or at NFC terminal associated with an authentication communication system 220). The smartcard 100 can transmit 410 the transaction data to the authentication communication system 220. The authentication communication system 220 can receive 412 via NFC communication, transaction data transmitted from the smartcard 100.

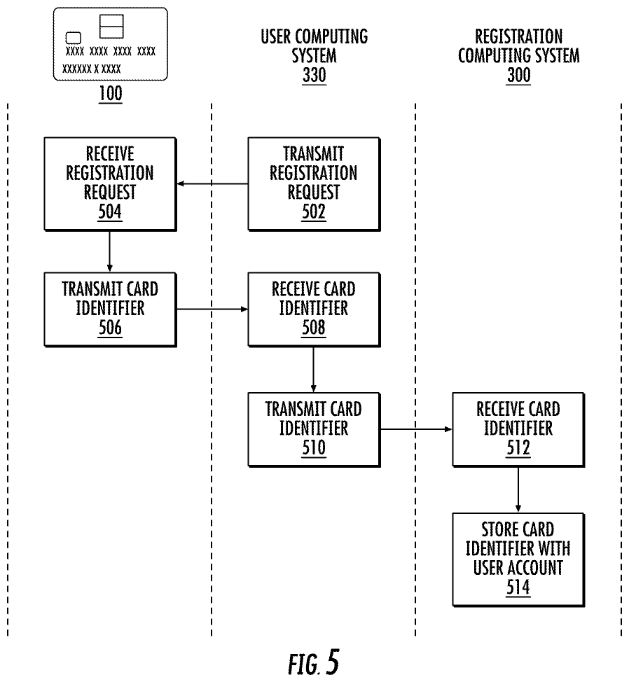

FIG. 5 is a flow chart representing interactions between a smartcard, a user computing system, and a user computing system in accordance with example embodiments of the present disclosure. In some examples, a user can initiate a registration process with the user computing system 330. In some examples, the user computing system 330 can include a registration application that performs the registration process.

As part of the registration process, the user computing system 330 can transmit a registration request 502 to the smartcard 100. As discussed above, communication between the user computing system 330 had the smartcard 100 can be accomplished via the NFC communication protocol.

The smartcard 100 can receive the registration request 504. In response to receiving the registration request 504, the smartcard 100 can transmit a unique smartcard identifier 506 to the user computing system 330. The unique smartcard identifier can be an identifier (e.g., a number) that represents this specific smartcard and cannot be changed easily. In this way, the smartcard 100 can always be identified by its particular unique smartcard identifier. The user computing system 330 can receive the unique smartcard identifier 508.

The user computing system 330 can transmit the card identifier 510 as part of the registration request to the registration computing system 300. In some examples, the user computing system 330 can also transmit a user account identifier along with the card identifier to the registration computing system 300. Using the user account identifier and the unique smartcard identifier, the registration request can cause the unique smartcard identifier to be associated with the user account.

The registration computing system 300 can receive the unique smartcard identifier 512. In some examples, the registration computing system 300 also receives an identifier of a user account along with the unique smartcard identifier. The unique smartcard identifier can be stored 514 in associated with the user account.

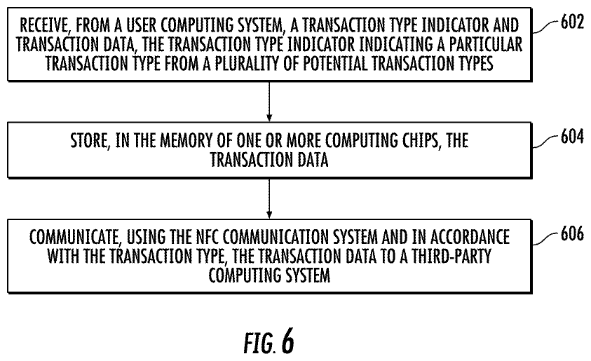

FIG. 6 is a flowchart depicting an example process of provisioning a smartcard to perform a particular function in accordance with example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1-3.

In some examples, the smartcard (e.g., smartcard 100 in FIG. 1) includes an NFC communication system configured to communicate with remote computing systems and one or more computing chips embedded in the smartcard, the one or more embedded computing chips comprising one or more processors and one or more computer-readable media, the memory including executable instructions that, when executed by the one or more processors. In some examples, the executable instructions can be an application configured to be executed in a limited computing environment. In some examples, the application can be a Java applet. In some examples, the smartcard can store a unique card identifier in the computer-readable media. In some examples, the unique smartcard identifier can be generated at the time the smartcard is created and stored permanently in the computer-readable media of the smartcard.

In some examples, the executable instructions are further configured to receive, from the user computing system, a registration request. In response to receiving the registration request, the smartcard can transmit, to the user computing system, the unique card identifier for storage at a remote server computing system.

In some examples, the smartcard can perform encrypted communications using one or more cryptographic algorithms. In some examples, the one or more computing chips included in the smartcard can include a secure element. The secure element can be enabled to communicate securely with other computing systems. In some examples, the smartcard can perform any of a plurality of interactive or non-interactive cryptographic protocols. For example, the protocol can include passing a token part of a blockchain as a one-time only transaction. In this case, the token can be received from a provisioning computing system and is read-only such that it is not altered (or even decrypted) by the smartcard. In another example, the communication protocol can include a blockchain commitment redemption or a stored valued decrement and sign.

In some examples, the smartcard 100 can receive at 602, from a provisioning computing system accessible to a user, a transaction type indicator and transaction data, the transaction type indicator indicating a particular transaction type from a plurality of potential transaction types. In some examples, transaction types can include, but are not limited to, a second-factor authentication, a purchase transaction, a virtual key transaction, and a user identification transaction.

In some examples, the smartcard can, at 604, store, in the computer-readable media of the one or more computing chips, the transaction data. In some examples, the computer-readable media simultaneously stores transaction data for a plurality of transaction types. In other examples, storing the transaction data in the computer-readable media further comprises removing, from the computer-readable media, previous transaction data associated with a previous transaction type and replacing it with the transaction data for the indicated transaction type.

In some examples, the smartcard can communicate at 606 the transaction data to an authentication computing system using the NFC communication system and in accordance with the transaction type. The authentication computing system can include an NFC terminal in a store, a lock mechanism in a vehicle or building, an employee authentication system, or the user computing device of a user. In some examples, communication to a third-party computing system is initiated when the smartcard is placed within NFC communication range of the third-party computing system by a user. The transaction data can include information describing a communication process associated with the received transaction type. The communication between the smartcard and the authentication computing system can be organized based on the communication process described in the transaction data.

In some examples, the transaction type is second-factor authentication. When the transaction type is authentication, the smartcard can receive, from the user computing system, a user credential code. In some examples, the user credential code can be a code that is prearranged with a particular authentication system to be used for second-factor authentication. In this case, different user credential codes can be established for each potential authentication system.

In some examples, the smartcard can transmit, using the NFC communication system, the user credential code to an authentication computing system in response to the user placing the smartcard within communication distance of the authentication computing system.

In some examples, the transaction type can be a virtual key transaction. When the transaction type is a virtual key transaction, the smartcard can receive, from the user computing system, vehicle access data. The smartcard can transmit, using the NFC communication system, the vehicle access data to a vehicle in response to the user placing the smartcard within communication distance of the vehicle.

In some examples, the transaction type can be a transportation payment associated with a particular transit system. In this case, the smartcard can receive, from the user computing system, transit account data, wherein the transit account data is associated with accessing a transit system. The smartcard can transmit, using the NFC communication system, the transit account data to a third-party computing system associated with the transit system to allow the user to access the transit system. In this way, the user can use the smartcard to access a subway or similar transit system quickly and easily.

In some examples, the transaction type is a payment transaction. In this case, the smartcard can receive, from the user computing system, payment account data, wherein the payment account data is associated with a payment account of the user. The smartcard can transmit, using the NFC communication system, the payment account data to a third-party computing system associated with a merchant to provide payment for a transaction.

In some examples, the transaction type can be a loyalty data transfer. For example, the smartcard can store a loyalty card identifier that can be transferred to a transaction system to enable loyalty rewards to be awarded to a user. In some examples, the smartcard can receive, from the user computing system, loyalty account data, wherein the loyal account data is associated with a loyalty account with a particular merchant. In some examples, the smartcard can transmit, using the NFC communication system, the loyalty account data to a third-party computing system associated with the particular merchant.

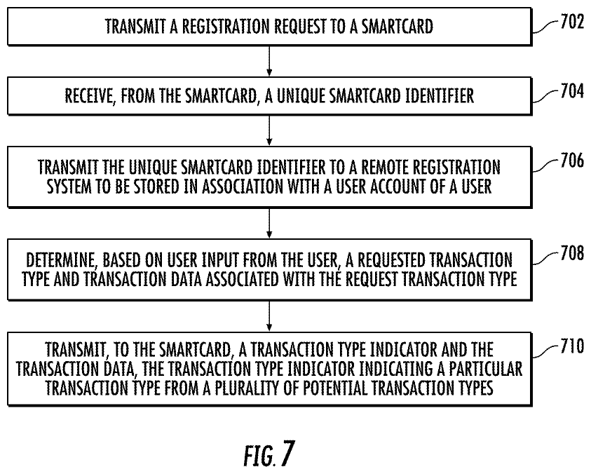

FIG. 7 is a flowchart depicting an example process of registering a smartcard with a registration server in accordance with example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1-3.

In some examples, a computing system (e.g., user computing system 330 in FIG. 3) can transmit, at 702, a registration request to a smartcard, the smartcard including one or more processors and computer-readable media. In some examples, the computing system can, at 704, receive, from the smartcard, a unique smartcard identifier. The unique smartcard identifier can be established when the smartcard is created.

In some examples, the computing system can transmit, at 706, the unique smartcard identifier to a remote registration system to be stored in associated with a user account of a user. The computing system can then determine, at 708, based on user input from the user, a requested transaction type and transaction data associated with the request transaction type, the user computing system can transmit, at 710, a transaction type indicator and the transaction data to the smartcard, the transaction type indicator indicating a particular transaction type from a plurality of potential transaction types.

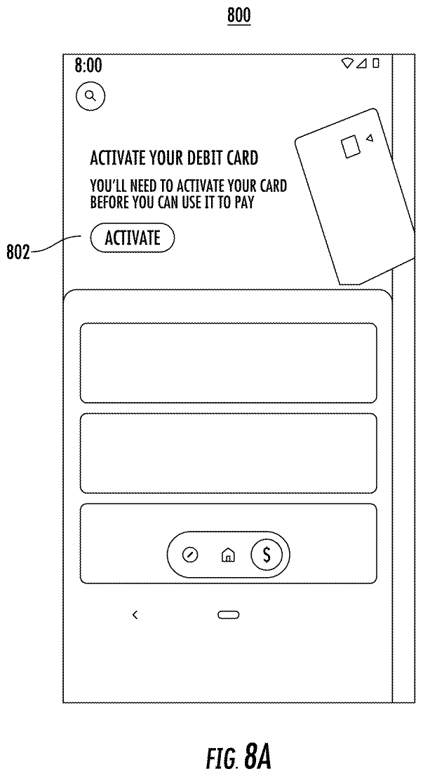

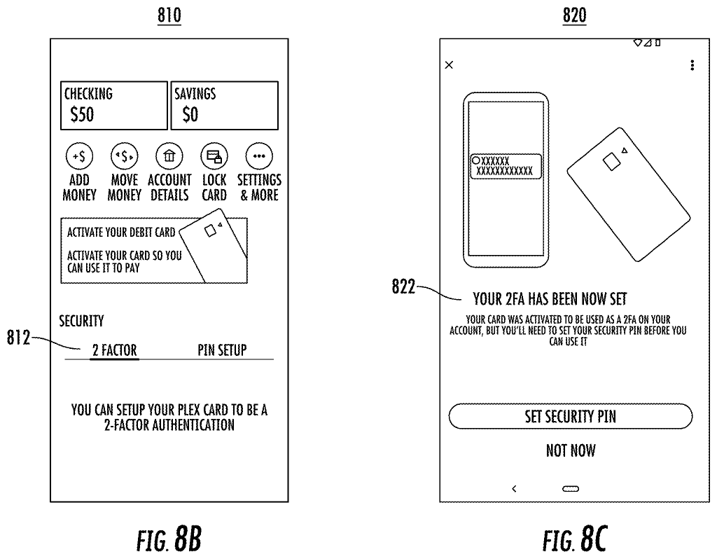

FIG. 8A is a diagram displaying an example interface 800 for registering a smartcard with a user account in accordance with example embodiments of the present disclosure. The displayed interface 800 can include a button 802 that allows the user to initiate a registration process. As discussed above, the registration process can include receiving a unique smartcard identifier from the smartcard and transmitting the unique smartcard identifier, along with an identifier of a user account, for registration.

FIG. 8B is a diagram displaying an example interface 810 for enabling a smartcard to perform a second-factor authentication transaction in accordance with example embodiments of the present disclosure. The interface includes, among other things, a user interface component 812 that allows a smartcard to be designated as a method for second-factor authentication.

FIG. 8C is a diagram displaying an example interface 820 for enabling a smartcard to perform a second-factor authentication transaction in accordance with example embodiments of the present disclosure. The interface includes, among other things, an indicator 822 that the smartcard has been provisioned to perform second-factor authentication.

The technology discussed herein refers to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A smartcard comprising:
a near-field communication (NFC) system configured to communicate with remote computing systems;
one or more computing chips embedded in the smartcard, the one or more embedded computing chips comprising one or more processors and one or more computer-readable media, the one or more computer-readable media including executable instructions that, when executed by the one or more processors, cause the smartcard to:
receive, from a provisioning computing system accessible to a user, a current transaction type indicator and current transaction data, the current transaction type indicator indicating a particular transaction type from a plurality of potential transaction types;
in response to receiving the current transaction type indicator and the current transaction data, remove, from the one or more computer-readable media of the one or more computing chips, previous transaction data associated with a previous transaction type;
store, in the one or more computer-readable media of the one or more computing chips, the current transaction data; and
communicate, using the NFC communication system and in accordance with the current transaction type indicator, the current transaction data to an authentication computing system.

2. The smartcard of claim 1, wherein the smartcard stores a unique card identifier in the one or more computer-readable media.

3. The smartcard of claim 2, wherein the executable instructions are further configured to:
receive, from the provisioning computing system, a registration request; and
transmit, to the provisioning computing system, the unique card identifier for storage at a remote server computing system.

4. The smartcard of claim 1, wherein the one or more computer-readable media simultaneously stores transaction data for a plurality of transaction types.

5. (canceled)

6. The smartcard of claim 1, wherein the particular transaction type is second-factor authentication and the executable instructions further enable the smartcard to:
receive, from the provisioning computing system, a user credential code; and
transmit, using the NFC communication system, the user credential code to an authentication computing system in response to the user placing the smartcard within communication distance of the authentication computing system.

7. The smartcard of claim 1, wherein the particular transaction type is accessing a vehicle and the executable instructions further enable the one or more computing chips to:
receive, from the provisioning computing system, vehicle access data; and
transmit, using the NFC communication system, the vehicle access data to a vehicle in response to the user placing the smartcard within communication distance of the vehicle.

8. The smartcard of claim 1, wherein the particular transaction type is a transportation payment associated with a particular transit system and the executable instructions further enable the one or more computing chips to:
receive, from the provisioning computing system, transit account data, wherein the transit account data is associated with accessing a transit system; and
transmit, using the NFC communication system, the transit account data to a third-party computing system associated with the transit system to allow the user to access the transit system.

9. The smartcard of claim 1, wherein the particular transaction type is a payment transaction and the executable instructions further enable the one or more computing chips to:
receive, from the provisioning computing system, payment account data, wherein the payment account data is associated with one or more payment accounts of the user; and
transmit, using the NFC communication system, the payment account data to a third-party computing system associated with a merchant to provide payment for a transaction.

10. The smartcard of claim 1, wherein the particular transaction type is a loyalty data transfer and the executable instructions further enable the one or more computing chips to:
receive, from the provisioning computing system, loyalty account data, wherein the loyal account data is associated with a loyalty account with a particular merchant; and
transmit, using the NFC communication system, the loyalty account data to a third-party computing system associated with the particular merchant.

11. The smartcard of claim 1, wherein the executable instructions enable the smartcard to perform encrypted communications using one or more cryptographic algorithms.

12. The smartcard of claim 11, wherein the one or more processors and the one or more processors comprise a secure element.

13. The smartcard of claim 12, wherein the executable instructions enable the secure element to securely communicate with other computing systems.

14. The smartcard of claim 1, wherein the current transaction data includes information describing a communication process associated with the received current transaction type.

15. The smartcard of claim 14, wherein the communication to the authentication computing system is organized based on the communication process described in the current transaction data.

16. The smartcard of claim 14, wherein the communication to the authentication computing system is initiated when the smartcard is placed within NFC communication range of the authentication computing system by a user.

17. The smartcard of claim 1, wherein the provisioning computing system is a smartphone.

18. A computer-implemented method comprising:
receiving, by a smartcard, a registration request from a user computing system, the smartcard having one or more embedded computing chips including a processor and one or more computer-readable media;
transmitting, by the smartcard to the user computing system, a unique smartcard identifier stored in the one or more computer-readable media of the smartcard so that the unique smartcard identifier can be associated with a particular user account at a registration server;
receiving, by the smartcard from the user computing system, a current user credential code for authenticating an identity of a user as part of a current transaction with a computing system;
in response to receiving the current user credential code, removing, from the one or more computer-readable media of the one or more computing chips, a previous user credential code associated with a previous transaction;
storing the current user credential code in the one or more computer-readable media of the one or more computing chips; and
communicating, by the smartcard, the current user credential code to an authentication computing system via a smart reader.

19. The method of claim 18, wherein the smartcard stores a unique card identifier in one or more computer-readable media.

20. A computing system for registering a smartcard, the system comprising:
one or more processors; and
one or more non-transitory, computer-readable media that store instructions that when executed by the one or more processors cause the computing system to perform operations, the operations comprising:
transmit a registration request to a smartcard, the smartcard including processing circuitry and memory;
receive, from the smartcard, a unique smartcard identifier;
transmit the unique smartcard identifier to a remote registration system to be stored in associated with a user account of a user;
determine, based on user input from the user, a requested transaction type and transaction data associated with the requested transaction type; and
transmit, to the smartcard, a transaction type indicator and the transaction data, the transaction type indicator indicating a particular transaction type from a plurality of potential transaction types, wherein transmitting the transaction type indicator and the transaction data results in the smartcard removing transaction data associated with a previous transaction from the memory of the smartcard.
